(19) United States
(12) Patent Application Publication
(10) Pub. No.: US 2010/0214762 A1
(43) Pub. Date: Aug. 26, 2010

(54) LAMP-HIDING ASSEMBLY FOR A DIRECT LIT BACKLIGHT

(76) Inventors: Timothy J. Nevitt, Red Wing, MN (US); Michael F. Weber, Shoreview, MN (US)

Correspondence Address: 3M INNOVATIVE PROPERTIES COMPANY, PO BOX 33427, ST. PAUL, MN, 55133-3427, US

(21) Appl. No.: 12/600,934

(22) PCT Filed: Apr. 15, 2008
(86) PCT No.: PCT/US08/60311

§ 371 Date: Mar. 30, 2010

Related U.S. Application Data
(60) Provisional application No. 60/939,081, filed on May 20, 2007.

(51) Int. Cl. F21V 13/08; F21V 7/00; G09F 13/04; G02B 27/28

(52) U.S. Cl. 362/19; 362/235; 362/97.1; 359/487

(57) ABSTRACT

The present invention is applicable to optical assemblies for use with direct-lit backlights that exhibit a lower transmission for light of normal incidence as compared to the transmission of light at higher angles of incidence, to accomplish a leveling effect of the light across the display. In one embodiment, an optical assembly includes a reflector having an internal Brewster angle and a reflective polarizer having orthogonal reflection and transmission axes. In another embodiment, a direct lit backlight assembly includes one or more lamps, a reflector having an internal Brewster angle, where a major surface of the reflector is facing at least one of the one or more lamps, and a light redirecting layer.

### FIELD OF THE INVENTION

The present invention relates to optical assemblies for use with backlights and to backlights, such as those used in liquid crystal display (LCD) devices and similar displays, as well as to methods of making backlights and optical assemblies for use with backlights.

### BACKGROUND

Recent years have seen tremendous growth in the number and variety of display devices available to the public. Computers (whether desktop, laptop, or notebook), personal digital assistants (PDAs), mobile phones, and thin LCD TVs are but a few examples. Although some of these devices can use ordinary ambient light to view the display, most include a backlight to make the display visible.

Many such backlights fall into the categories of “edge lit” or “direct lit”. These categories differ in the placement of the light sources relative to the output face of the backlight, where the output face defines the viewable area of the display device. In edge lit backlights, a light source is disposed along an outer border of the backlight construction, outside the area or zone corresponding to the output face. The light source typically emits light into a light guide, which has length and width dimensions on the order of the output face and from which light is extracted to illuminate the output face. In direct lit backlights, an array of light sources is disposed directly behind the output face, and a diffuser is placed in front of the light sources to provide a more uniform light output. Some direct lit backlights also incorporate an edge-mounted light source, and are thus capable of both direct lit and edge lit operation.

### BRIEF SUMMARY

In one embodiment, an optical assembly includes a reflector having an internal Brewster angle and a reflective polarizer having orthogonal reflection and transmission axes.

In another embodiment, a direct lit backlight assembly includes one or more lamps, a reflector having an internal Brewster angle, where a major surface of the reflector is facing at least one of the one or more lamps, and a light redirecting layer.

In yet another embodiment of the invention, an optical assembly includes one or more lamps, a display panel, and a reflector having an internal Brewster angle. The reflector is a multilayer interference film of at least three layers, where at least one of the layers is birefringent and a refractive index in the x-direction (nₓ) is less than a refractive index in the z-direction (n_{z}), where the x-direction is an in-plane direction. The reflector is located between the lamps and the display panel.

In another embodiment, an optical assembly includes a backlight reflector having a smooth side, wherein the reflector has an internal Brewster angle of less than 90 degrees in air, wherein the internal reflectivity inside the film for one polarization is zero for a certain angle. The reflector has a reflectance of 50% or greater at normal incidence.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements.

FIG. 1 is a perspective exploded view of a direct lit backlight in combination with a liquid crystal display.

FIG. 2 is a schematic cross-sectional view of first embodiment of a direct lit backlight assembly.

FIG. 3 is a plan view of one embodiment of a direct lit backlight.

FIG. 4 is a plan view of an embodiment of a direct lit backlight that utilizes compact light sources such as LEDs.

FIG. 5 is an idealized graph showing brightness versus position on at least a portion of the output face of a backlight.

FIG. 6 shows a two layer stack of films forming a single interface, with notations showing how various indices of refraction will be labeled.

FIG. 7 is a schematic view of conditions for various indices of refraction in a multilayer construction and how they increase or eliminate an internal Brewster angle of the construction.

FIG. 8 is another schematic view of conditions for various indices of refraction in a multilayer construction and how they decrease or eliminate an internal Brewster angle of the construction.

FIG. 9 is a graph of reflectivity versus angle for several multilayer birefringent reflectors that have internal Brewster angles accessible for light incident from air.

FIGS. 10 and 11 are top and side views, respectively, of a reflector having disc-shaped portions that is used in one embodiment of an optical assembly.

FIG. 12 is a cross-sectional view of another embodiment of a direct lit backlight assembly.

FIG. 13 is a cross-sectional view of another embodiment of a direct lit backlight assembly.

FIG. 14 is a cross-sectional view of yet another embodiment of a direct lit backlight assembly.

FIG. 15 is a graph of reflectivity versus angle for one interface of an sPS/PMMA reflector for s and p polarized light.

FIG. 16 is a graph of reflectivity versus angle for the air interface of another embodiment of an sPS/PMMA reflector.

FIG. 17 is a cross-sectional view of another embodiment of a direct lit backlight assembly.

FIG. 18 is a schematic view of an embodiment of a reflector.

FIG. 19 is a graph of reflectivity versus angle for the air interface of an embodiment of an sPS/Silicone reflector of FIG. 18.

FIG. 20 is a graph of the reflectivity as a function of angle for an sPS/silicone polyamide reflector of FIG. 18.

FIG. 21 is a schematic view of an embodiment of a reflector.

FIG. 22 is a schematic view of the strong axis of the reflector of FIG. 21.

FIG. 23 is a graph of the reflectivity as a function of angle for the strong axis of the reflector of FIG. 21.

FIG. 24 is a schematic view of the weak axis of the reflector of FIG. 21.

FIG. 25 is a graph of the reflectivity as a function of angle for the weak axis of the reflector of FIG. 21.

FIG. 26 is a schematic view of a strong axis of another embodiment of a reflector.

FIG. 27 is a graph of the reflectivity as a function of angle for the strong axis of the reflector of FIG. 26.

FIG. 28 is a schematic view of the weak axis of the embodiment for which the strong axis is illustrated in FIG. 26.

FIG. 29 is a graph of the reflectivity as a function of angle for the weak axis of the reflector of FIG. 28.

FIG. 30 is a graph of relative intensity measurements plotted against lateral position relative to a light source for three different backlight configurations.

FIG. 31 is a graph of a preferred reflectance and transmittance spectrum for a reflector.

### DETAILED DESCRIPTION OF THE ILLUSTRATIVE EMBODIMENTS

The present invention is applicable to optical assemblies for use with direct-lit backlights that exhibit a lower transmission for light of normal incidence as compared to the transmission of light at higher angles of incidence. In practice this means that a lower percentage of light is transmitted through an optical assembly in the region near a light source where the intensity is the highest, compared to regions further from the light source where the intensity is lower but which have a higher percent transmission. The net effect is a leveling of the transmitted light intensity across the face of the direct-lit backlight. As a result, a viewer is less likely to perceive a brighter area directly above a light source on a direct-lit backlight. Optical assemblies of this type are particularly useful in the context of direct-lit display devices, such as LCD display devices, including large area LCD TV's or desktop monitors.

A reflector can provide the desired transmission characteristics to level out the light output if it has an internal Brewster angle, so that the reflector has a reflectivity for p-polarized light that decreases as an angle of incidence increases, as will be explained in greater detail herein. The materials and structure of the reflector can be carefully chosen so that it has an appropriately high value for reflectivity at and near normal incidence, but light rays at higher angles of incidence are more likely to be transmitted. As a result, only a fairly small portion of the light emitted by light sources of a direct-lit backlight will be passed through the display in the area directly above the light source. At areas of the display not directly above the light sources, a higher proportion of light passes through.

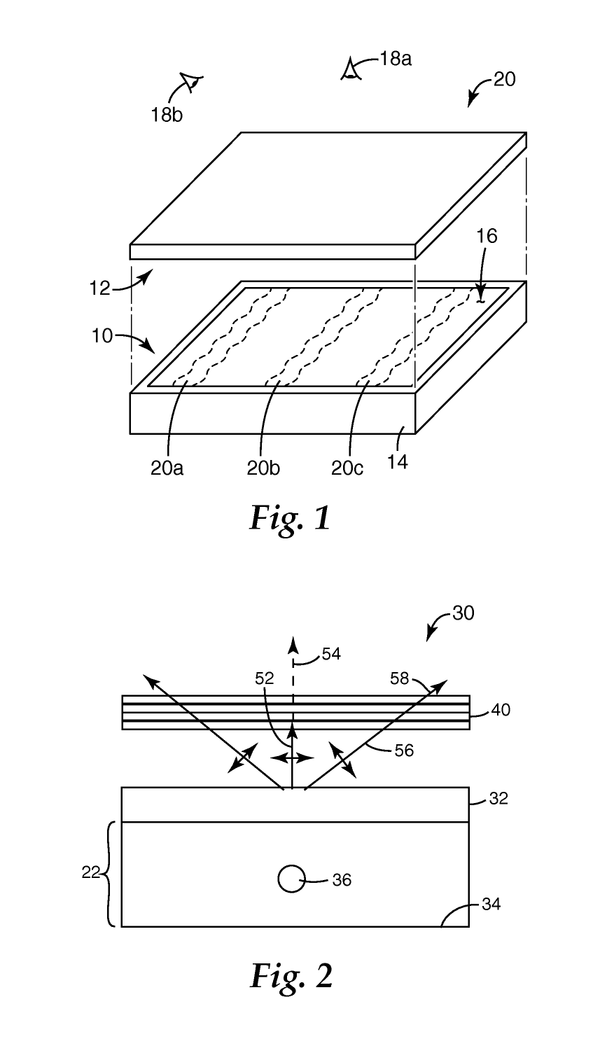

The general structure of a direct-lit backlight will now be described. FIG. 1 illustrates in perspective exploded view of an optical assembly 20 that includes a direct lit backlight 10 in combination with a display panel 12, such as a liquid crystal display (LCD) panel. Both backlight 10 and display panel 12 are shown in a simplified box-like form, but the reader will understand that each contains additional detail. Backlight 10 includes a frame 14 and an extended output face 16. In operation, the entire output face 16 is illuminated by light source(s) disposed within the frame 14 behind the output face. When illuminated, the backlight 10 makes visible for a variety of observers 18a, 18b an image or graphic provided by display panel 12. The image or graphic is produced by an array of typically thousands or millions of individual picture elements (pixels), which array substantially fills the lateral extent (length and width) of the display panel 12. In most embodiments, the backlight 14 emits white light and the pixel array is organized in groups of multicolored pixels (such as red/green/blue (RGB) pixels, red/green/blue/white (RGBW) pixels, and the like) so that the displayed image is polychromatic. In some cases, however, it may be desirable to provide a monochrome display. In those cases the backlight 10 can include filters or specific light sources that emit predominantly in one visible wavelength or color.

Alternatively, the light sources can be sequentially powered sources of multiple monochrome light emitting devices, such as red, green and blue LEDs.

Backlight 10 in FIG. 1 is depicted as including three elongated light sources disposed behind the output face 16 as indicated by source zones 20a, 20b, and 20c. Areas of the output face 16 between or otherwise outside of the source zones are referred to herein as gap zones. The output face 16 can therefore be considered as being made up of a complementary set of source zones and gap zones. The existence of source zones and gap zones are a consequence of the fact that the light sources, even if they are extended, are both individually and collectively much smaller in projected area (plan view) than the output face of the backlight. In most embodiments, in order to provide optimum image quality from the display, it is desirable to configure the backlight 10 such that the brightness at the output face 16 is as uniform as possible. In those cases, the brightness in the source zones should be substantially the same as the brightness in the gap zones.

FIG. 2 is a schematic sectional view of a direct lit backlight 30 capable of achieving such uniformity. Backlight 30 includes a front reflective polarizer 32, a back reflector 34, and a lamp 36. Reflective polarizer 32 and back reflector 34 form a light recycling cavity 22, within which light can undergo successive reflections. The reflective polarizer transmits light of a first polarization state, and reflects light of a second polarization state orthogonal to the first polarization state, where the two states are substantially plane-polarized along orthogonal (90 degree) in-plane directions.

Cholesteric reflective polarizers, when combined with a quarter-wave retarder, can perform this function and are useful in this invention, as are wire grid reflective polarizers and diffuse reflective polarizers such as the DRPF (diffusely reflective polarizing film) products available from 3M Company. In general, any reflective polarizer that reflects light having its plane of polarization parallel to one axis and transmits light having its plane of polarization parallel to an orthogonal axis is suitable for use with this invention. Conventional planar multilayer films that reflect s-polarized light and substantially transmit p-polarized light are not an option for this polarizer. Instead such films are useful as reflector 40, as discussed below. The proper combination of the two is useful for providing a uniform spatial intensity in backlights having light sources with linear portions such as fluorescent lamps.

FIG. 2 also includes a reflector 40 having an internal Brewster angle, such as an isotropic layered structure. The term internal Brewster angle refers to a Brewster angle at an interface that is internal to the reflector and not at an interface with air or other components in the system. One purpose of the reflective polarizer 32 is to deliver, to the reflector 40, predominantly p-polarized light in a plane of incidence perpendicular to a linear light source. Reflector 40 has a reflectivity for p-polarized light that decreases as an angle of incidence increases. The reflective polarizer is also useful for prepolarizing the light in displays that utilize absorbing polarizers. For example, a multilayer birefringent polarizer, such as for example a dual brightness enhancement film (DBEF) product available from 3M Company under the Vikuiti brand, can deliver p-polarized light to the reflector in the plane perpendicular to an axis of a light source. The order of placement can be changed such that the positions of the reflector 40 and the reflective polarizer 32 can be interchanged without loss of functionality if the losses in both components are small.

At low angles of incidence, the reflectivity of the reflector 40 is high for p-polarized light, so that only a small portion of light with a low angle of incidence is propagated all the way through the reflector 40. For example, light ray 52 in FIG. 2 is normal to the surface of the reflector 40, therefore having a zero degree angle of incidence. As a result, only a small portion of the incident light 52 emerges from the reflector as light ray 54. At higher angles of incidence, the reflectivity of the reflector 40 is lower for p-polarized light, so that a larger portion of light is propagated all the way through the reflector 40. For example, light ray 56 is incident upon the reflector at a higher angle of incidence, so a larger portion emerges from the reflector as light ray 58. In most embodiments of the invention, the reflective polarizer 32 does not have an internal Brewster angle though in other embodiments the reflective polarizer does have an internal Brewster angle. If reflective polarizer 32 is a multilayer birefringent reflective polarizer it may possess an internal Brewster angle along the pass axis, which is substantially transmissive, even at normal incidence. It may even possess an internal Brewster angle along the block (reflective) axis, provided it substantially reflects light parallel to that axis for both s- and p-polarized light at all angles of incidence. In some embodiments, the reflective polarizer does not have an internal Brewster angle in the plane of incidence that is parallel to a block axis of the reflective polarizer.

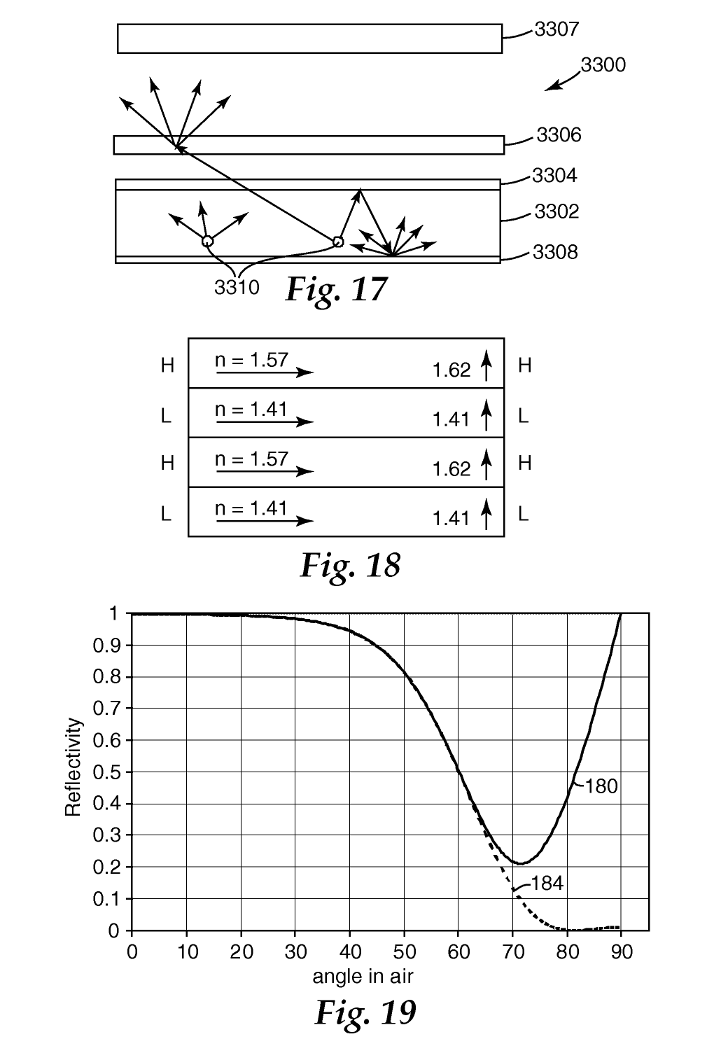

It is also possible for an optical assembly of the present invention to be constructed without a reflective polarizer. For example, a backlight constructed with omni directional point sources of light, such as, for example, LEDs, may not require a directional source of p-polarized light to the reflector 40, because there is no directional aspect to the emission of light. FIG. 17 provides an example of such an optical assembly. FIG. 17 illustrates backlight 3300, which includes a light cavity 3302, a reflector with an internal Brewster angle 3304, a diffuser 3306 and an optical light directing film 3307. The light cavity 3302 includes a diffuse mirror 3308, and a number of point, serpentine or line light sources 3310. Although a uniform backlight can be constructed without the use of a reflective polarizer, a reflective polarizer may still be desirable for prepolarizing and recycling polarized light in displays that utilize absorbing polarizers. There are also displays that do not require polarized light, such as backlit signage.

### Examples and Characterizations of Direct-Lit Backlights

As discussed above, the backlight configuration of FIG. 2 helps to hide a lamp in a direct-lit backlight by making the output of the backlight more uniform across its surface. Other backlight configurations that help to hide a lamp will also be described further herein. But first, more general types of direct-lit backlights will be discussed including backlights using line sources, serpentine sources and point sources. Direct-lit backlight 10 in FIG. 1 illustrates three sources 20a-c. These sources are three individual discrete linear lamps in one embodiment, commonly known as line sources. Turning now to FIG. 3, a plan view of another exemplary backlight 21 is illustrated where light sources 23a-c are portions of a larger serpentine lamp 24.

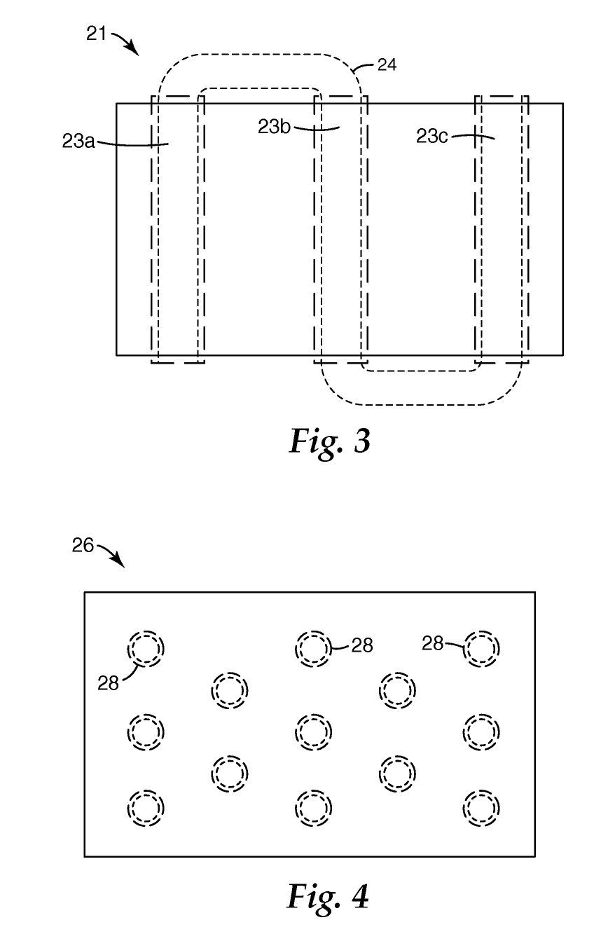

FIG. 4 shows a plan view of an alternative backlight 26 including an array of compact or small area light sources 28. These sources may be, for example, LED sources. Examples of LED-based light sources are described in the following commonly-assigned patent applications: U.S. Patent Application Publication US 2004/0150997 A1 (Ouderkirk et al.), U.S. Patent Application Publication US 2005/0001537 A1 (West et al.), and U.S. patent application Ser. No. 10/977,582, “Polarized LED”, filed Oct. 29, 2004.

Common types of direct-lit backlights are line, serpentine or point sources. The lamps in direct-lit backlights are directly behind the output face of the backlight, rather than along an outer border of a backlight construction. A direct-lit backlight is one where the locations where photons are created or originated, such as lamps, are substantially within a projected area of the display area. For example, a direct-lit backlight 10 includes a display area, such as display area 16 in FIG. 2. The lamp 36 is within the projected area of the display area 16. Similarly, lamp 36 is within the projected area of a major surface of the reflector 40. Another way of describing a direct-lit backlight is one where a projected area of a display area is significantly larger than a projected area of a lamp or light source. In contrast to direct-lit backlights, side-lit backlights are typically configured with a lamp that is not within a projected area of a display area. Instead, in a side-lit backlight, a lamp runs along an edge of the display area and off to the side.

Uniform vs. Unmodified Light Output for a Direct-Lit Backlight

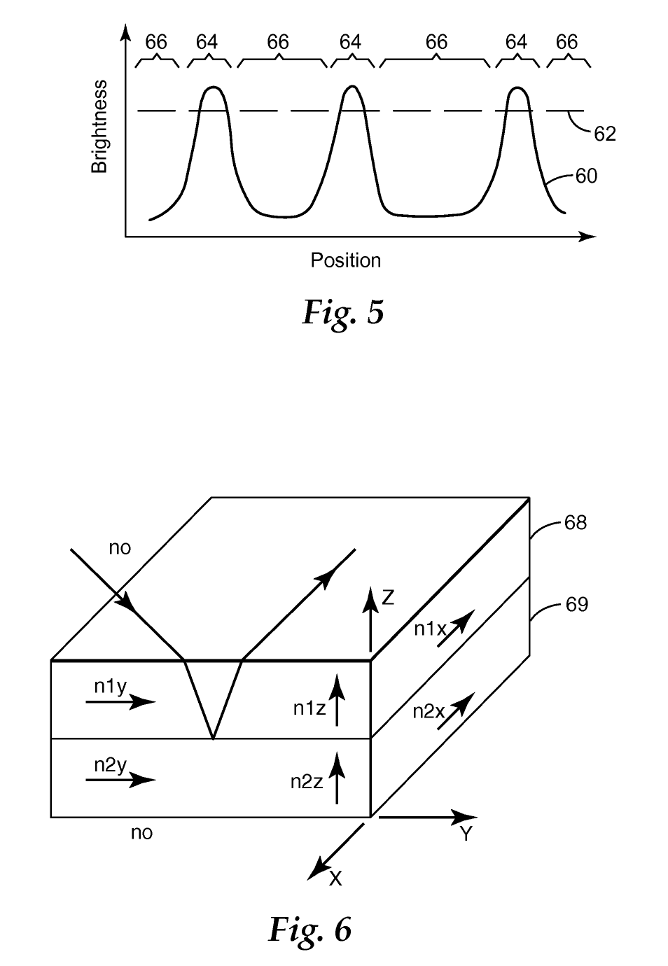

FIG. 5 is an idealized plot of brightness of the backlight along a path that extends across all or a portion of the backlight's output surface. The path is selected to include zones of the output surface immediately above the light sources, i.e., source zones 64, as well as zones of the output surface not immediately above any light source, i.e., gap zones 66. For curve 60, the reflector 40 is not present in the device to selectively reflect light. Thus, the source zones 64 become relative bright spots between relatively dark gap zones 66.

Curve 62 shows an idealized output for a backlight where steps are taken according to the invention to level the light intensity across the surface of the backlight, such as including a reflector 40 with a Brewster angle in the device. In that case, light transmitted through the reflective polarizer 32 at low angles of incidence are largely reflected by the reflector 40 and are transmitted to only a small degree. In that special case, light transmitted through the reflective polarizer towards the front of the display is reflected from and transmitted by the reflector 40 in amounts that cause the source zones 64 to have a brightness that substantially matches that of the gap zones 66. In this way, highly uniform illumination in a high brightness direct lit backlight can be achieved. Since perfect uniformity is rarely achievable for real systems, the characteristics of the device can be adjusted to minimize brightness variability over all or some portion of the output surface of the backlight.

Examples of a Reflector having an Internal Brewster Angle

The term reflector refers to a structure having a reflectance of at least about 30%. In various embodiments, the reflector will have a reflectance of at least about 50%, 80% or 90%. Unless otherwise stated, all reflectance values refer to reflectance at normal incidence.

For light incident on a plane boundary between two regions having different refractive indices, a Brewster angle is the angle of incidence at which the reflectance is zero for light that has its electrical field vector in the plane defined by the direction of propagation and the normal to the surface. In other words, for light incident on a plane boundary between two regions having different refractive indices, a Brewster angle is the angle of incidence at which the reflectance is zero for p-polarized light. For propagation from a first isotropic medium, having a refractive index of m, to a second isotropic medium, having a refractive index of n₂, Brewster's angle is given as arc tan (n₂/n₁). An internal Brewster angle can be present in an optical structure when there is an interface within the structure between adjacent portions having two different indices of refraction. An interference film, including material of alternating low and high index of refraction, can have an internal Brewster angle. However, an optical assembly with multiple layers does not necessarily have an internal Brewster angle. For example, if one or both of the alternating layers in a multilayer mirror are birefringent, and the z-indices of refraction of the layers have certain differential values relative to the in-plane indices, then no Brewster angle will exist. Alternatively, with another set of relative n_{z} difference values, the value of the Brewster angle can be dramatically reduced. To help illustrate this behavior, two birefringent material layers forming an interface are shown in FIG. 6, with notations showing the labels for the indices of refraction for a first material 68 and a second material 69. Each material layer in general can have different indices in the x, y, and z directions as shown in FIG. 6.

The Brewster angle θ_{B} at an interface of two dielectric material layers, for light polarized in the y-z plane, is given by:

$${sin}^{2} {θ}_{B} = \frac{{n}_{2 z}^{2} {n}_{1 z}^{2} ( {n}_{1 y}^{2} - {n}_{2 y}^{2} )}{{n}_{0}^{2} ( {n}_{1 z}^{2} {n}_{1 y}^{2} - {n}_{2 z}^{2} {n}_{2 y}^{2} )}$$

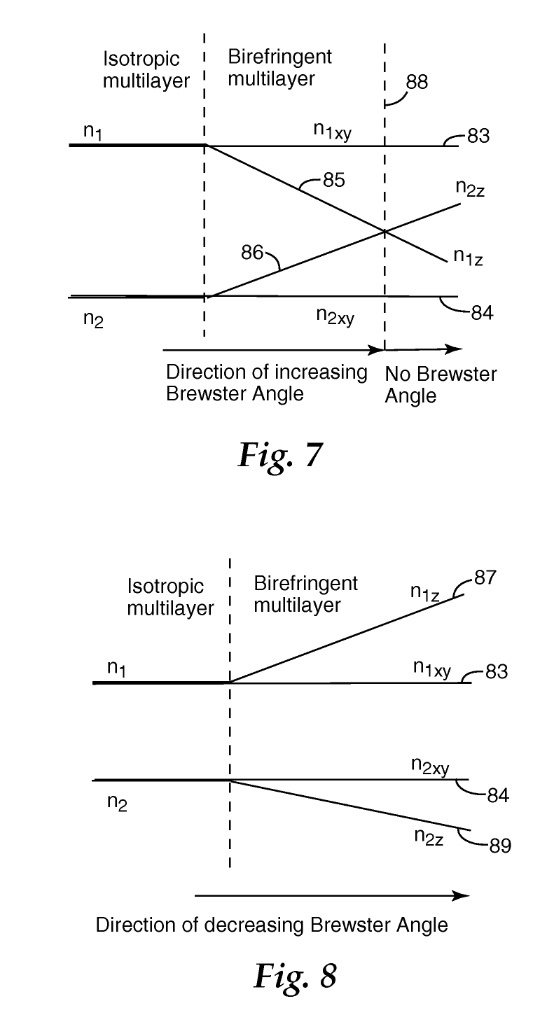

For light incident in the x-z plane, the values for n_{y} in this equation are replaced by those of nₓ. The relative values of nₓ, n_{y}, and n_{z} can dramatically affect the value and existence of the internal Brewster angle. Although there are a continuum of possibilities, the general effects fall into two main categories which can be summarized by the diagrams in FIGS. 7 and 8. FIG. 7 illustrates the optical material combinations which increase the value of the internal Brewster angle beyond those obtainable with isotropic materials, or eliminate the internal Brewster angle. This set of conditions is one where the difference in n_{z} between the first material 68 and the second material 69 is less than the difference of the in-plane indices for the given plane of incidence. Lines 83 and 84 represent the values of nₓ or n_{y} for the first and second materials, respectively, where the difference between nᵢₓ and n₂ₓ is shown staying constant, and the difference between n_{iy} and n_{2y} is shown staying constant. Lines 85 and 86 represent the values of n_{1z} and n₂, demonstrating that as the difference between n_{1z} and n_{2z} decreases, the internal Brewster angle increases. At line 88, which is the intersection between lines 85 and 86 where the n_{z} difference vanishes, the Brewster angle also vanishes. Increasing Δn_{z} past this point is of an opposite sign compared to the Δn_{xy} and the reflectivity of p-polarized light now increases with the angle of incidence, similar to the reflectance for s-polarized light. One or both of the materials can be birefringent, but the same relations hold, regardless of which material is birefringent.

FIG. 8 illustrates the preferred optical material combinations for the present invention which allow the construction of reflectors which can transmit substantial portions of p-polarized light at angles of incidence from air to a planar surface. With the proper index sets these reflectors can exhibit an enhanced Brewster effect such that the Brewster angle can be accessed with light incident from air on planar interfaces. This is not possible for most multilayer reflectors made with isotropic materials. However, the proper choice of birefringent materials can result in a larger difference for n_{z} between first material layers 68 and second material layer 69 (FIG. 6) than for the in-plane index difference of the same layers:

Δn_{z}=(n_{1z}−n_{2z})>(n₁ₓ−n₂ₓ) or (n_{1z}−Δn_{z})>(n_{1y}−n_{2y})

Like FIG. 7, FIG. 8 shows lines 83 and 84 representing the values of nₓ or n_{y} for the first and second materials, respectively, where the difference between n₁ₓ and n₂ₓ is shown staying constant, and the difference between n_{1y} and n_{2y} is shown staying constant. Lines 87 and 88 represent the values of n_{1z} and n_{2z}, demonstrating that as the difference between n_{1z} and n_{2z} is increasing beyond the difference between n_{xy} values, the internal Brewster angle decreasing.

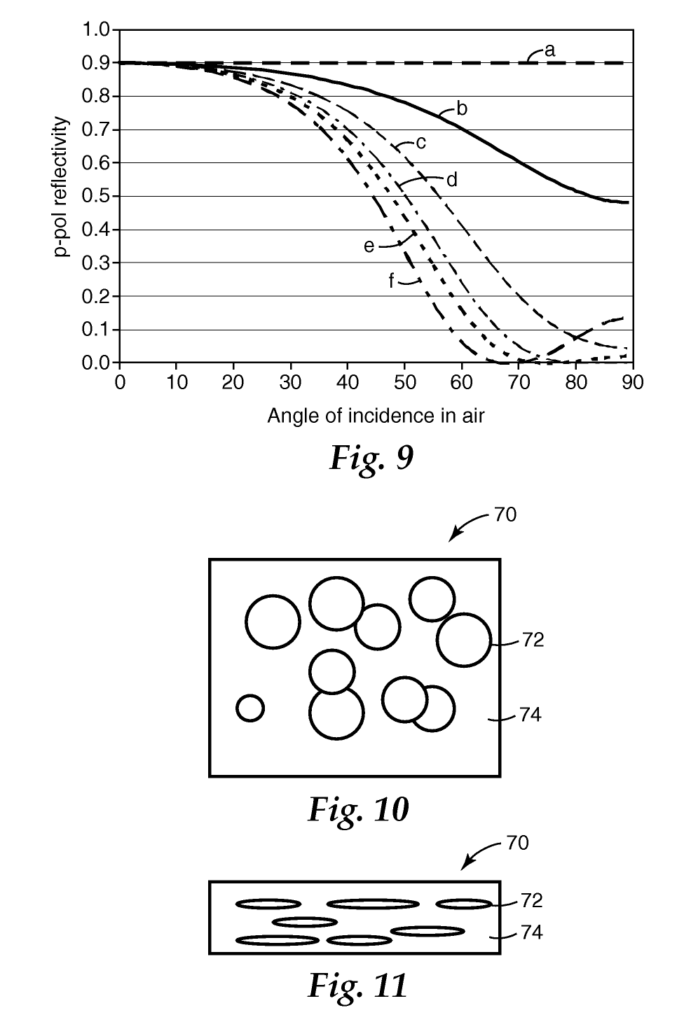

The larger the value of Δn_{z} relative to Δnₓ, the smaller the value of the Brewster angle for p-polarized light incident in the xz-plane on this interface, as illustrated in FIG. 9, which is further described herein. FIG. 9 was created for constant values of nₓ and n_{y}, with increasing values of Δn_{z}.

For any of these constructions, the existence of a Brewster angle is useful only if it exists for a substantial portion of the layers in a multilayer stack. If additional functional coatings or layers of a third or fourth material are added to the multilayer stack, these materials may create a different value of a Brewster angle with whatever material they are in contact with. If such materials have relatively few interfaces compared to the number of interfaces of first and second materials, such interfaces will not substantially impact the performance of the present invention. Where the multilayer stack includes mostly layers of first and second materials, but some layers are slight variations in the composition of first and second materials, the effect on the overall stack may be a broader Brewster angle minimum but the overall effect is similar to that with just two materials.

The desired performance of multilayer reflectors having an internal Brewster angle is one with relatively high reflectivity at normal incidence and a lower reflectivity (higher transmission) at oblique angles of incidence.

In general any multilayer reflector where Δn_{z} between adjacent, alternating layers is of the same sign as Δnₓ or Δn_{y}, will exhibit an internal Brewster angle and is useful in this invention. In general the in-plane indices along the x- and y-axes need not be equal. There is a continuum between the uniaxial case where the x- and y-directions have identical indices, the biaxial case where nₓ≠n_{y}≠n_{z}, and the uniaxial case where nₓ≠n_{y}=n_{z}.

Material Interfaces with Multiple Internal Brewster Angles

Birefringent multilayer reflectors can be made with oriented (stretched) birefringent polymeric materials. By using different stretch ratios in the x- and y-directions, an asymmetric reflector can be made which has very different values for the internal Brewster angle for those respective directions. A schematic index set is illustrated in FIG. 21. In accordance with the information presented in FIG. 8, a Brewster angle will exist for light incident in either the x-z or the y-z plane for the film pairing of FIG. 21. The z-index is of course the same for light incident in either the x-z or the y-z plane but since the Δn_{z}/Δn_{y} ratio is larger than the Δn_{z}/Δnₓ ratio, the internal Brewster condition occurs at a smaller angle for the y-z plane than for the x-z plane. A continuum of internal Brewster angle values exist for the azimuthal angles between the x-z and the y-z planes. Thus, multilayer reflectors made with only two materials can exhibit different Brewster angles along different in-plane directions. For efficient hiding of light sources, a relatively high reflectivity at normal incidence may be desired along all in-plane directions. In some embodiments, the reflectivity is greater than about 50% along either axis. Examples with specific materials are given below.

If the reflectivity of such an asymmetric reflector is much higher for one axis than for the other, the reflector can perform the function of a reflective polarizer in polarizing light from the backlight as well as providing for a more spatially uniform light output from the backlight. In general, if it is to provide for polarization recycling, or “gain”, then the ratio of transmission for the “pass” axis should be on the order of or greater than at least twice the transmission of the “block axis”.

Referring back to FIG. 2, for systems that are illuminated with linear light sources or approximate linear arrays of point lights sources, the “block” axis of this asymmetric reflector is preferably aligned with this linear direction.

The reflector of this invention transmits predominately oblique rays of light and a light redirecting layer such as a diffuser, prismatic film, or beaded “gain diffuser” film or the like is used in some embodiments to provide light of normal incidence to the display and the viewer, as further discussed herein. If the reflector is to also function as a prepolarizer or polarization recycling film, the light redirecting layer should not substantially depolarize the light transmitted by the reflector. If a diffuser or light redirecting film substantially depolarizes the light, then a separate reflective polarizer may be added between the reflector and the display panel.

There are many possibilities for the structure of reflector 40 which will be further discussed herein. For example, the reflector 40 is a multilayer stack of isotropic materials in one embodiment. Further exemplary constructions of the reflector 40 will now be described.

### Reflector is a Birefringent Layered Structure

Birefringent layered structures are described, for example, in U.S. Pat. No. 5,882,774. In general, the preferred multilayer reflector 40 is one wherein the z-axis index difference if greater than one or both of the x and y-axis index differences.

For certain embodiments of a biaxial birefringent layered structure used as a reflector, the reflectance along at least one in-plane axis is at least about 50% or at least about 60%.

When considering the Brewster angle, another important issue is whether an internal Brewster angle of an optical structure will be accessible in air. FIG. 9 illustrates the modeled reflectivity in air of multilayer stacks of birefringent and isotropic layers having in-plane indices of 1.57 and 1.41. The values for n_{1z} range from 1.41 for plot a to 1.7 for plot f. As a result, the Δn_{z} values range from 0 for plot a to 0.29 for plot f. A reflectance of 90% at normal incidence from 400 to 800 nm is achievable with about 400 alternating layers of two materials having these in-plane indices. The reflectivity values shown in FIG. 9 do not include surface reflections, that is, the contribution from the air-polymer interfaces are not included in the calculations. The larger Δn_{z} is, compared to Δnₓ, the lower the Brewster angle. Plot d is representative of a configuration where the internal Brewster angle is about 78° and n_{1z}=1.62, which is readily achievable by using sPS as the high index material and a silicone polyox-amide. The use of silicone polyox-amide is described in co-pending and co-owned patent application U.S. Appl. No. 60/753,857, filed Dec. 23, 2005. The Brewster angle can of course also be reduced by lowering the value of n_{z}, relative to n₂ₓ, i.e. by using a birefringent material of the appropriate sign for the low index layers.

### Reflector has Disc-Shaped Voids

In one exemplary embodiment illustrated in FIGS. 10 and 11, a reflector 70 is a discontinuous phase material that includes voids in the form of, for example, isotropic platelets or discs 72 in an isotropic medium 74. The advantage of the voided material is that the Brewster angle can be as low as about 50 degrees in air. Voids can be created in polymer films by the use of foaming agents during extrusion or molding, a process well known in the art.

Preferably, the material is isotropic and the voids have aspect ratios of diameter (D) to thickness (t) of about 3:1 or greater. The aspect ratios are more preferably about 10:1 or greater. In other embodiments, the void areas may have an oval profile. In order to achieve the Brewster angle effect in continuous media having a discontinuous or disperse phase, the disperse phase particle or void size is much larger than the wavelength of light and preferably have approximately planar surfaces such as oblate spheroids which approach the shape of flat discs.

In one embodiment, an isotropic voided material is made, for example, with foamed PMMA (Polymethyl methacrylate). See, for example “Foaming Polymethyl methacrylate with an Equilibrium Mixture of Carbon Dioxide and Isopropanol” by R. Gendron and P. Moulinie in Journal of Cellular Plastics March 2004, vol. 40, no. 2, pp. 111-130(20). Cyclic olefins are another class of isotropic polymers that are voided to make an isotropic air/polymer mirror. In addition, cyclic olefins can typically be stretched at higher ratios than PMMA to give higher aspect ratios in the voids.

In an exemplary embodiment, the disc-shaped portions have a lower index of refraction than the surrounding material. In another embodiment, the disc-shaped portions have a higher index of refraction than the surrounding material.

A number of different constructions have been discussed for the reflector having an internal Brewster angle, and further constructions will now be described. In addition, it is important to note that different reflector constructions may be used with different backlight configurations, such as backlight configurations having various light extraction layers that are further discussed herein. The reflector is made with isotropic film layers in some embodiments, and with specially tailored birefringent layers in other embodiments. Additional reflector constructions will now be described.

### Reflector is PEN and PMMA Layers

In one exemplary embodiment, the reflector 92 is a multilayer structure that includes 530 isotropic layers of PEN (polyethylene naphthalate) and PMMA. The individual layers range in thickness from about 500 nm to 2000 nm.

### Reflector is PEN/THV Layers

In one embodiment, the reflector is a layered structure with layers alternating between oriented PEN and THV (a polymer of tetrafluoroethylene, hexa fluoropropylene and vinylidene fluoride, sold as 3M′s Dyneon™ THV Fluorothermo-plastic material). In one embodiment, the oriented PEN layers have nₓ=n_{y}=1.75 and n_{z}=1.49, while the THV layers have n=1.35. In other embodiments, the reflector is an oriented PET/THV mirror. In one example, the oriented PET (polyethylene teraphalate) layers have nₓ=n_{y}=1.65 and n_{z}=1.49. These types of reflectors have internal Brewster angles (measured in the incident medium) of 54 degrees and 51 degrees respectively when immersed in acrylic (n=1.49). Reflectors of PEN/THV can be made with reflectivity of about 99% at normal incidence. In air however, the p-polarized reflections will decrease with angle from 99% at normal incidence to 90% at 90 degrees for PEN/THV and from 99% to 80% for PET/THV. Preferably, the PEN/THV type construction is used in combination with light injection and/or extraction components.

### Reflector is sPS and PMMA Layers

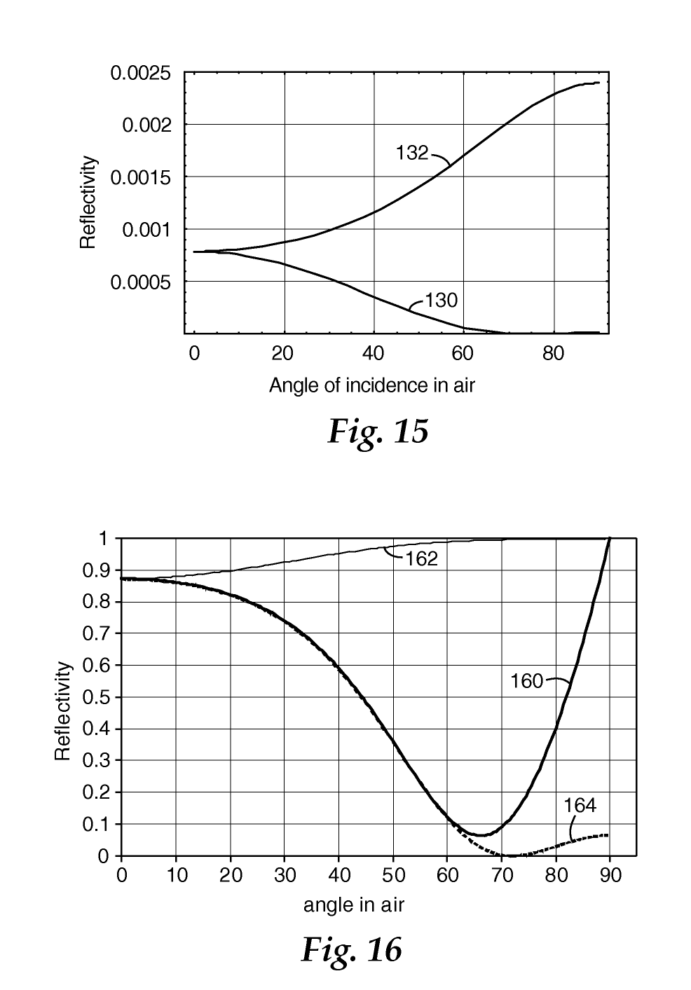

In another exemplary embodiment, a multilayer reflector can be made with alternating layers of syndiotactic polystyrene (sPS) and PMMA. The sPS material can be biaxially oriented to achieve in-plane (x-y) indices of approximately 1.57 (depending on wavelength) while the thickness- or z-index is approximately 1.62. Unless otherwise noted, all indices of refraction refer to values at a wavelength of 633 nm. The PMMA will remain substantially isotropic with an index of about 1.49 upon orientation of the multilayer reflector film. The angle dependency of reflectivity for a single interface of this sPS and PMMA for s- and p-polarized light, plotted against the angle of incidence upon the multilayer reflector film in air, is shown in FIG. 15. Curve 130 shows the reflectivity for p-polarized light while curve 132 shows the reflectivity for s-polarized light. A multilayer sPS/PMMA reflector can be designed to have any desired amount of reflectivity from about 10% to 90% at normal incidence. The reflectivity for p-polarized light will drop proportionately as the angle of incidence increases. Another exemplary embodiment of an sPS/PMMA reflector has about 80% reflectivity at normal incidence.

When a multilayer film of these materials is used in conjunction with a reflecting polarizer that blocks s-polarized light which has an E-field direction parallel to a line source of light, then only p-polarized light will strike the film in the plane perpendicular to the line source. In this manner, the total light transmitted in this plane will increase with angle of incidence, reaching a maximum at the internal Brewster angle, which in this case is about 74 degrees in air, as shown where curve 130 approaches zero reflectivity.

FIG. 16 graphs a model of the angle dependency of reflectivity of a multilayer quarter-wave stack of sPS/PMMA for s- and p-polarized light having the same indices of refraction discussed above with respect to FIG. 15. Curve 160 shows the reflectivity for p-polarized light for the film stack, including the two air interfaces, curve 162 shows the reflectivity for s-polarized light, and curve 164 graphs the reflectivity for p-polarized light for the stack only with air interfaces removed. The difference between curves 160 and 164 illustrates the effects of the surface reflections, which generally have a different value for the Brewster angle and the reflection magnitude than do the internal interfaces of the film stack. The Brewster angle of about 74 degrees when light is incident from air is illustrated by the minimum in the curve 164 of FIG. 16. The minimum of curve 160 illustrates the Brewster angle for the combination of internal and air interfaces.

The small index differential of sPS/PMMA multilayer reflector embodiments requires that a large number of layers be used to achieve high reflectivity over the visible spectrum. About 1500 layers are required to achieve the modeled reflectivity of 87% at normal incidence illustrated in FIG. 16.

### Reflector is sPS and Silicone Polyamide Layers

Higher reflectivity with fewer layers can be achieved if one uses silicone polyamide as the low index material. One example for a structure for a reflector that has sPS and silicone polyamide layers and can achieve acceptable reflectivity is illustrated in FIG. 18, where the isotropic layers have a refractive index of 1.41, and the alternating layers have a z-index of 1.62 and an in-plane index of 1.57. Using about 1000 layers, a reflector can be made with a reflectivity over a spectrum of about 400 to 850 nanometers at normal incidence of about 99.5%. The reflectance vs. angle curves for such a mirror are shown in FIG. 19. Curve 180 shows the reflectivity for p-polarized light for a film stack in air and curve 184 graphs the reflectivity for p-polarized light for the stack with no air interfaces. An acceptable mirror can also be made using only a few hundred layers.

The use of reflectors with Brewster angles accessible in air can provide improved bulb hiding, compared to reflectors made with all isotropic layers, while maintaining a high efficiency backlight. This is possible because such reflectors can be made to have up to or more than 99% reflectivity at normal incidence and still have essentially zero reflectivity at an angle less than 90 degrees in air. A number of embodiments of backlights incorporating these reflectors do not include a microstructure to inject or extract the light from such a reflector. A diffuser or light redirecting film is still present in many embodiments so as to provide a desired angular distribution of light to the display. For example, a randomizing diffuser is placed above the reflector, or a sheet of BEF is placed above the reflector along with an optional diffuser sheet having an optimized level of diffusion.

In other embodiments of the invention, isotropic multilayer reflectors are used, although the reflectivity does not decrease as rapidly with angle, unless the reflector is immersed. Immersion can be accomplished by applying a structured surface to the reflector. Lamination of a “gain diffuser” or other beaded or prismatic structures to the surface can accomplish this effect.

Asymmetric Reflector with two Brewster Angles

With an asymmetric stretch of the appropriate multilayer stack, one in-plane axis of a reflector can have a much lower Brewster angle compared to its orthogonal in-plane axis. In this manner, at least one axis of the reflector can have an internal Brewster angle near 60 degrees in air. This value is close to the air/polymer Brewster angle. This is important because at high angles, the surface reflections dominate the light transmission through a film. These asymmetric reflectors can improve the efficiency of a backlight while still providing equal or better bulb hiding characteristics.

One example of a reflector having an internal Brewster angle that can be used with the backlight configurations described herein is made with stacks of negative birefringent polymer layers and alternating layers of either a low index isotropic polymer or a low index positive birefringent polymer. A negative birefringent polymer is defined as one whose index of refraction decreases in the stretch direction while one or both of the indices in the orthogonal directions simultaneously increases. A positive birefringent polymer is defined as one whose index of refraction increases in the stretch direction while one or both of the indices in the orthogonal directions simultaneously decreases.

The polymer stack is oriented in only one direction, or in general with any asymmetric stretch, creating an asymmetric reflector. When used in a backlight, this reflector can be combined with a diffuser and optionally with a standard reflective polarizer to aid in hiding bright point sources of light.

By using an asymmetric orientation, one axis can have high reflectivity and the other axis can be provided with an internal Brewster angle as low as 60 degrees in air with larger index differential materials. When combined with a standard multilayer reflective polarizer and diffuser, bright light sources can be effectively masked.

Reflector is Symmetrical Biaxially Oriented sPS/Silicone Polyamide Layers

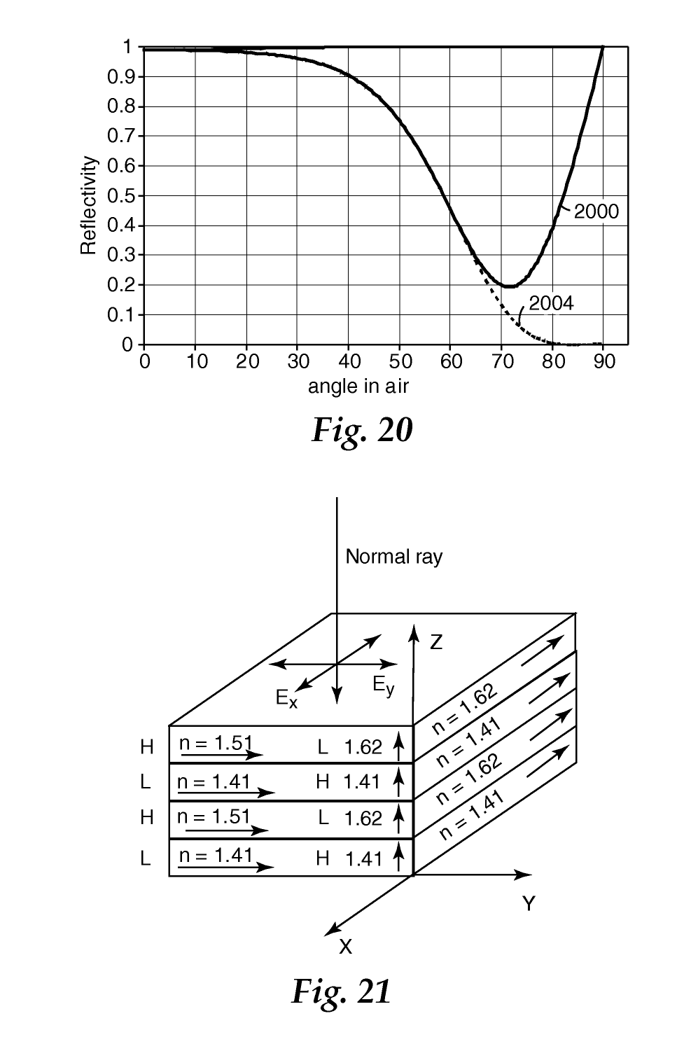

One embodiment of a reflector having an internal Brewster angle is a symmetrically, biaxially oriented sPS/silicone polyamide reflector. Silicone polyamide has an index of 1.41, which is considerably lower than that of PMMA and can provide a reflector with high reflectivity while using a manageable number of layers. The indices of refraction for the two materials for this embodiment are the same as illustrated in FIG. 18. The isotropic layers have a refractive index of 1.41, and the alternating birefringent layers have a z-index of 1.62 and an in-plane index of 1.57. The indices of refraction are the same for both stretch directions in this case. As modeled, the reflectivity as a function of angle is shown in FIG. 20 for this reflector stack for a 400 layer stack which reflects light from 400 to 850 nm. Curve 2000 shows the reflectivity for p-polarized light for the multilayer stack and its air interfaces, and curve 2004 graphs the reflectivity for p-polarized light for the stack only with surface-air interface reflections removed. Peak reflectivity for p-polarized light is about 90% at zero degrees. The Brewster angle is at about 85 degrees and surface reflections cause the minimum for total reflectivity for p-polarized light to shift to about 70 degrees with about 15% minimum reflectance.

Uniaxially Oriented sPS/Silicone Polyamide Layers

One embodiment of an asymmetric reflector having two Brewster angles is a stack of uniaxially oriented sPS/silicone polyamide layers. In one example, the stack of this embodiment has about 210 layer pairs and reflectivity of 99% at zero degrees for light polarized along the non-stretch axis or strong axis. When a stack of sPS and SPA is uniaxially oriented as in a standard tenter, the stack index set illustrated in FIG. 21 can be obtained.

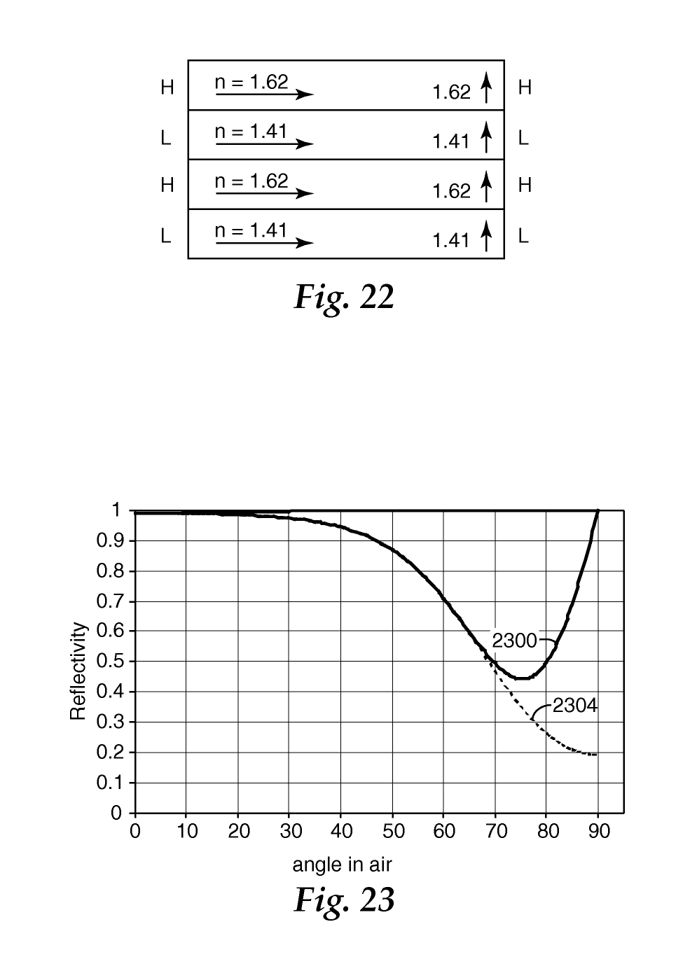

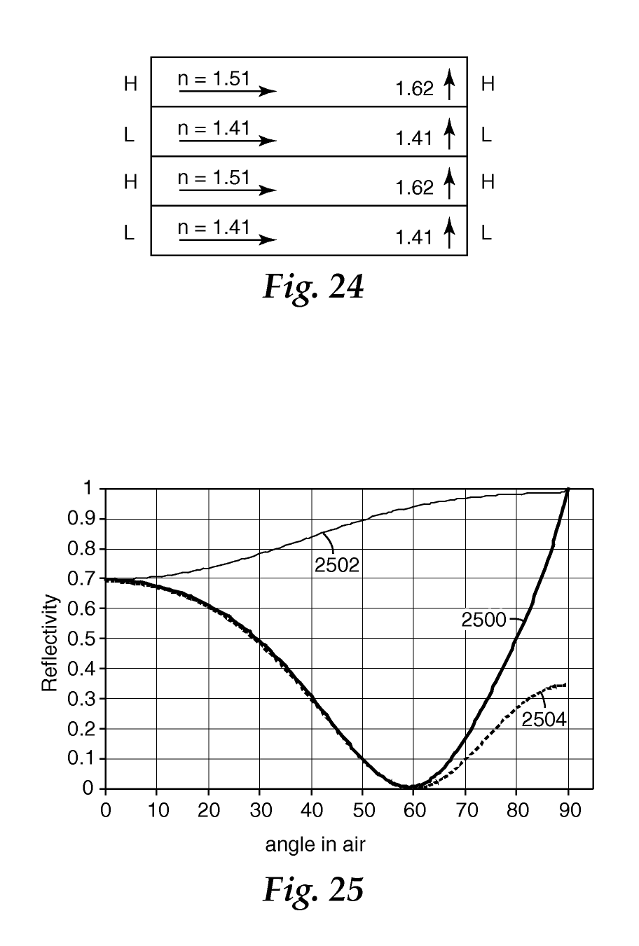

The reflectivity of this reflector design has a weak and a strong axis. The strong axis, illustrated in FIG. 22, has a 0.21 index differential. The weak axis, illustrated in FIG. 24 has only a 0.10 index differential. The reflectivity is plotted against the angle in air for the strong axis in FIG. 23. Curve 2300 shows the reflectivity for p-polarized light for the stack with two air interfaces. Curve 2304 graphs the reflectivity for p-polarized light for the film stack with no air interfaces.

The reflectivity is plotted against the angle in air for the weak axis in FIG. 25. Curve 2500 shows the reflectivity for p-polarized light for the film stack with two air interfaces. Curve 2502 shows the reflectivity for s-polarized light, and curve 2504 graphs the reflectivity for p-polarized light for the stack without air interfaces.

Both axes have an internal Brewster angle, but as illustrated in FIGS. 23 and 25, the two Brewster angles are very different. The strong axis has an internal Brewster angle of greater than 90 degrees for the film stack, while the weak axis has an internal Brewster angle of about 60 degrees. Note that the Brewster angle for the internal layer interfaces is about the same as that of the air interfaces. When used in combination and aligned properly with a reflective polarizer such as DBEF or APF (Advanced Polarizer Film, such as APF-ND, sold under the Vikuiti™ brand by 3M Company) and a light redirecting layer, as occurs in an embodiment of the invention, significant bulb hiding is possible.

Reflector is sPS/THV Layers

One embodiment of a reflector having two Brewster angles is similar to the embodiment of FIG. 21, but the silicone polyamide of index 1.41 is replaced with THV of index 1.35. Much fewer layers, about 120 layer pairs, are needed to achieve the same effect. The film stacks of these examples can be oriented in any asymmetrical fashion from near uniform biaxial to a true uniaxial stretch in order to maximize this effect.

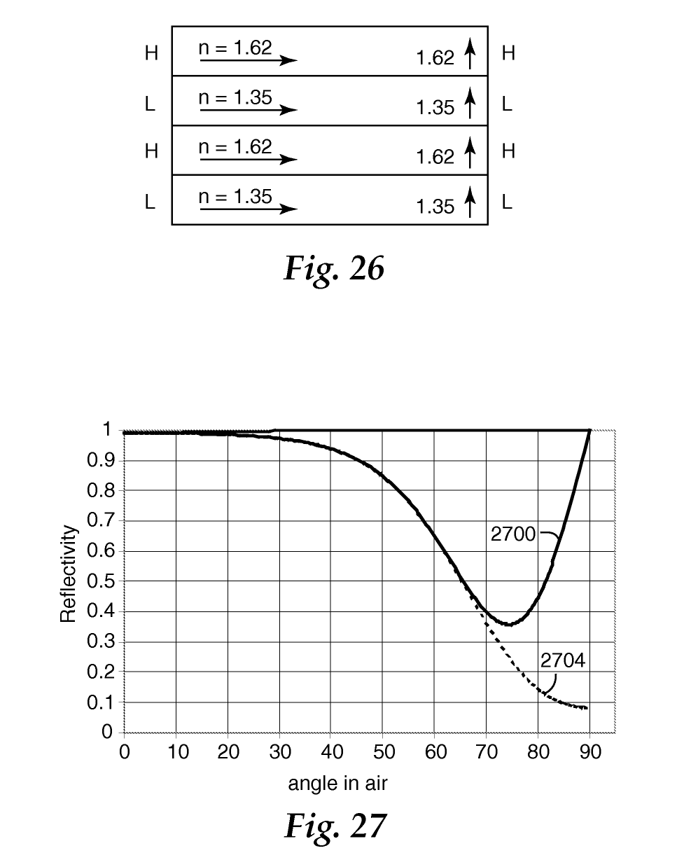

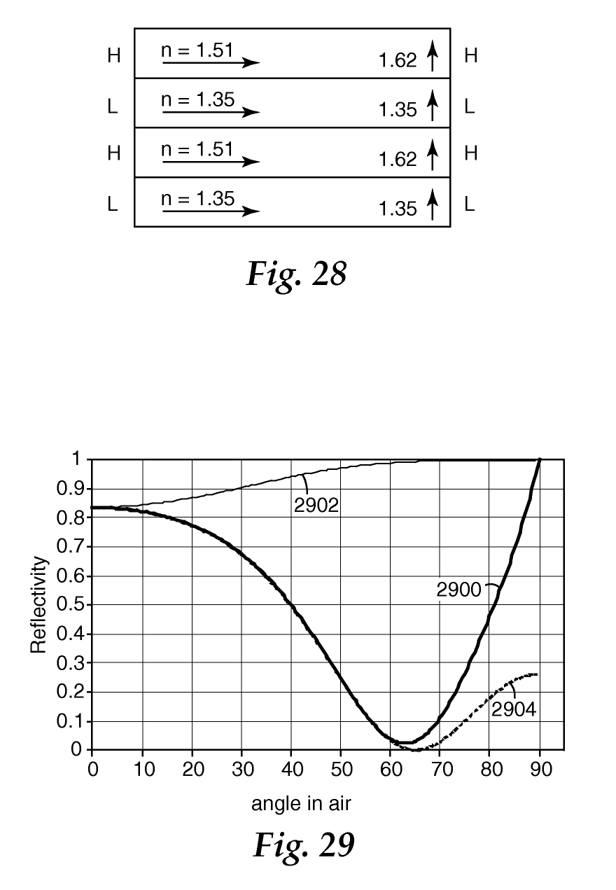

Similar to the embodiment of FIG. 21, the reflectivity of this reflector design has a weak and a strong axis. The strong axis, illustrated in FIG. 26, has a 0.27 index differential. The weak axis, illustrated in FIG. 28 has a 0.16 in-plane index differential. The reflectivity is plotted against the angle in air for the strong axis in FIG. 27. Curve 2700 shows the reflectivity for p-polarized light for the stack with two air interfaces and curve 2704 graphs the reflectivity for p-polarized light for the stack alone.

The reflectivity is plotted against the angle in air for the weak axis in FIG. 29. Curve 2900 shows the reflectivity for p-polarized light for the stack plus air interfaces, curve 2902 shows the reflectivity for s-polarized light, and curve 2904 graphs the reflectivity for p-polarized light for the stack without air interfaces. Note that minima for 2900 and 2904, with and without air interfaces, are similar in this case.

Both axes have an internal Brewster angle, but as illustrated in FIGS. 27 and 29, the two Brewster angles are very different. The strong axis has an internal Brewster angle of greater than 90 degrees for the film stack, while the weak axis has an internal Brewster angle of about 65 degrees. When used in combination and aligned properly with a reflective polarizer such as DBEF or APF and a diffuser, as occurs in an embodiment of the invention, significant bulb hiding is possible.

Other preferred material combinations for multilayer reflectors that are useful in this invention use one of the following materials for the higher-index layer: coPEN, copolymers of PET, and PENg (a high index amorphous PEN). The term coPEN includes any copolyester of PET or polyethylene naphthalate. Examples of useful materials for the lower index materials include PMMA, silicone polyoxamide and THV.

Backlight Embodiments with Light Injection Layer and/or Extraction Layer

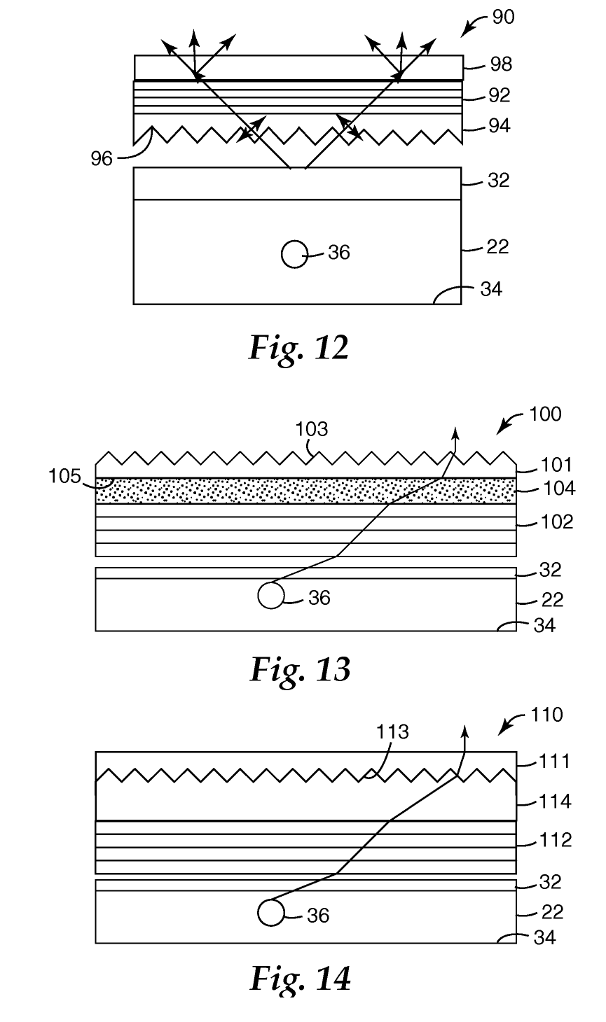

Reflectors with solid interfaces most often have Brewster angles that typically cannot be accessed from air for plane parallel interfaces. As a result, the reflector has lower overall transmission compared to the situation where a significant portion of the light impacting the reflector was doing so at the Brewster angle. The addition of structured surfaces or diffusers can make an otherwise inaccessible Brewster angle accessible by permitting the injection and extraction of light traversing reflectors at very high angles. One embodiment of a backlight 90 is illustrated in FIG. 12. In many ways similar to backlight 30 of FIG. 2, the backlight 90 includes a light cavity 22 having a reflective polarizer 32, a lamp 36 and a back reflector 34. The backlight 90 also includes a reflector 92 and a light redirecting layer 94. A light redirecting layer 94 is capable of modifying light distribution upon transmission of incident light. Layer 94 can also be referred to here as an injection layer.

In addition, systems operating with air interfaces without injection layers, such as shown in FIG. 2, also can benefit in some embodiments from a light redirecting layer, even if an extraction layer is not needed. Although the existing components of FIG. 2—light source, reflector 40 and polarizer 32—may be able to provide a uniform intensity of light to the LCD panel, in some embodiments the light is directed out to the side instead of towards the viewer. The light redirecting layer in some embodiments is a diffuser. The diffuser can randomize the direction of light exiting the reflector 40. Alternatively, the prismatic film of FIG. 14 may be used. Neither has to be laminated, i.e. an air gap may work as well or better.

Examples of structures that can act as light redirecting layers include a diffuser, a volume diffuser, and a surface structure such as a prismatic assembly, e.g. a brightness enhancement film. When the light redirecting layer 94 is a prismatic structure as illustrated in FIG. 12, the prism grooves 96 are aligned parallel to the axis of the lamp 36. One example of a prismatic structure that can be used is an Optical Lighting Film sold by 3M Company.

The diffuser can also have an additional important function. It randomizes the direction of the light, but also should transmit substantial amounts of incident light. A diffuser that is capable of randomizing the direction of light will typically also reflect substantial portions of the light back into the backlight. The reflectivity of such a diffuser increases with angle of incidence, i.e. it is lowest at normal incidence. This effect, when combined with the opposite effect of increasing transmission of reflector 40 with angle of incidence, provides a leveling effect to the intensity across the face of the backlight.

A reflector 92 with an internal Brewster angle as discussed herein is intended to preferentially transmit high angle rays as compared to normal incidence rays. However, most display devices require that the light eventually be directed normal to a display surface, so that the display luminance is highest for a viewer directly in front of the display. To extract light that is transmitted near the Brewster angle, a second light redirecting layer 98 is included on the exit side of the reflector 92 in the embodiment illustrated in FIG. 12. Layer 98 can also be referred to as an extraction layer or extractor. In one embodiment, the backlight 90 includes both the light redirecting layer 94 acting as a light injection layer and the light redirecting layer 98 acting as a light extraction layer. In other embodiments, the backlight 90 includes only one of the two light redirecting layers 94, 98.

Structures described above as examples of the light redirecting layer 94 can also serve as the light redirecting layer 98. In one preferred embodiment, the light redirecting layer 98 is CG 3536 Scotch Cal diffuser film sold by 3M Company. Lamination of a “gain diffuser” or other beaded or prismatic structures to the surface can also be used as a light redirecting layer 94 and/or light redirecting layer 98.

One example of a polarizer 32 for use in the structure of FIG. 12 is a 275 layer film of uniaxially oriented 90/10 coPEN (copolymer of polyethylene naphthalate) coextruded with PETG (glycolised polyester). In another embodiment, a diffuse reflecting polarizer is used as the polarizer.

Reflectors that exhibit an internal Brewster angle accessible in air without resorting to structured or diffuse injection layers have the advantage of requiring fewer components and thus are potentially less expensive lower cost. These reflectors can be made using polymers having a negative stress optical coefficient in a multilayer construction as described above.

### Prismatic Film as Redirecting Layer

Another backlight embodiment that is capable of directing light exiting the backlight closer to the normal is shown in FIG. 13. A backlight 100 includes a micro-structured prismatic film 101 positioned on the opposite side of the reflector 102 from a light cavity 22, with the prism structures 103 pointing away from the reflector. An optional adhesive layer 104 bonds the prismatic film 101 to the reflector 102. Like the other backlight embodiments that have been discussed, the light cavity 22 includes a reflective polarizer 32, a lamp 36 and a back reflector 34. The prismatic film 101 has a planar side 105 that is laminated to a freestanding reflector structure 102 in one embodiment. Alternatively, where the reflector is a multi-layer coated type of film, the reflector 102 is coated onto the planar side 105 of the prismatic film 101.

In an alternative embodiment shown in FIG. 14, the backlight 110 includes a micro-structured prismatic film 111 positioned with the prism structures 113 pointing toward the reflector 112. An optional adhesive layer 114 bonds the micro-structured prismatic film 111 to the reflector 112. Like the other backlight embodiments that have been discussed, backlight 110 also includes a light cavity 22 having a reflective polarizer 32, a lamp 36 and a back reflector 34.

### Experimental Results

Experimental results for Examples 1 and 2 will now be described. The backlight structure 90 illustrated in FIG. 12 was built and tested as Example 1, having a diffuser as light extraction layer 98, such as CG 3536 Scotch Cal diffuser film available from 3M Company. Example 1 incorporates a prismatic layer as a light injection layer 94. To construct Example 1 for testing, a reflective polarizer 32 was laminated to an acrylic plate. This acrylic plate was positioned over the fluorescent bulb in the backlight 22, with the transmission axis of the reflective polarizer positioned orthogonal to the axis of the lamp 36. The isotropic reflector 92 with its bottom prismatic injection layer 94 and top extraction layer 98 was placed on top of this plate, leaving an air gap at the prismatic surface. The prismatic layer 94 and the extraction layer 98 were laminated to opposite sides of the isotropic reflector 92 with a clear adhesive. The isotropic reflector 92 of Example 1 was a multilayer PEN/PMMA stack having 530 layers. The individual layers ranged in thickness from about 500 nanometers to about 2000 nanometers. The indices of refraction for this reflector were 1.64 and 1.49 measured at 630 nanometers.

Example 2 is identical to Example 1, except that the light extraction layer 94 for Example 2 is 10 mil thick diffuser with particles with diameters of about 3 microns. The diffuser was measured for haze, clarity and transmission, with a BYK Gardner Hazegard Plus (T.M.) instrument, and has a haze value of 98%, clarity of 5% and transmission of 92%.

Relative light intensity was measured as a function of position across the face of the light box. The light box measured 10 cm×26.5 cm and was lined with ESR mirror film, which is multilayer polymeric Enhanced Specular Reflector (ESR) film available from 3M Company under the Vikuiti™ brand. The lamp was a fluorescent bulb running the length of the box and centered at 5 cm from each side wall. The bulb was held at a height of about 8 mm from the bottom of the box. The polarizer and other films were placed at about 16 mm from the bottom of the box. The polarizer 32 in Example 1 was a 275 layer film of uniaxially oriented 90/10 coPEN coextruded with PETG.

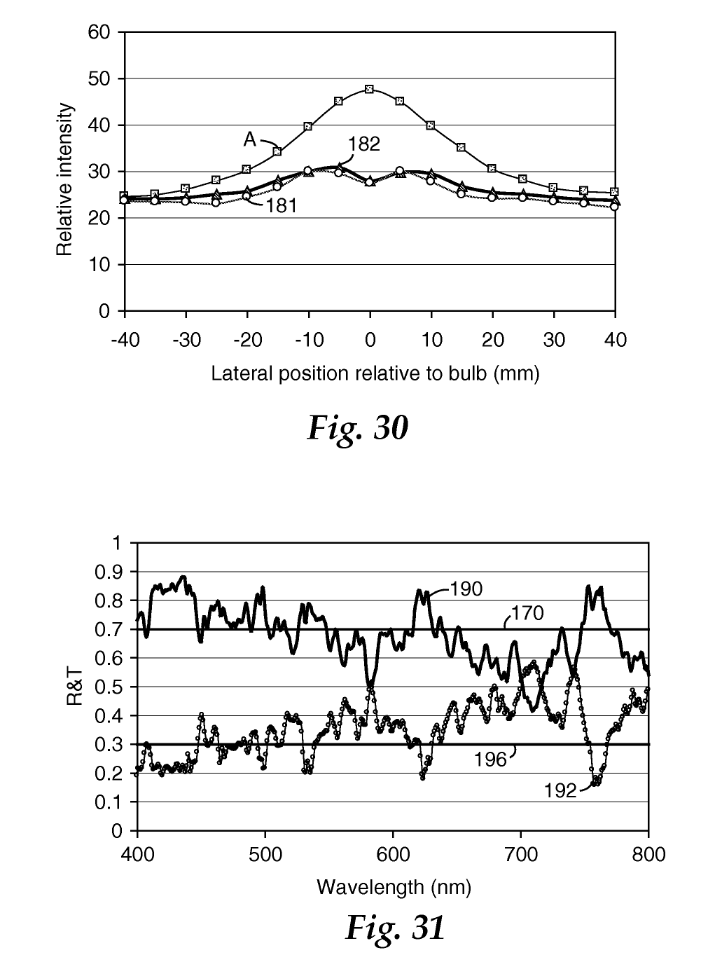

Positionally relative intensity measurements were made by measuring the short circuit current of a silicon photo detector equipped with a photopic filter. These intensity measurements for Example 1 are plotted in FIG. 30 as curve 181 and for Example 2 are plotted as curve 182. FIG. 30 also plots the spatial transmitted intensity of Comparison Example A, which is a 3 mm thick acrylic plate that was laminated on both sides with a diffuser, specifically aCG 3536 Scotch Cal diffuser film available from 3M Company. The large central intensity peak seen with the simple diffuser films in Comparison Example A was practically eliminated with the use of the structures of Examples 1 and 2.

Note that the total intensity over the face of the box for both Examples 1 and 2 is slightly lower than for the control Example A. Although the reflective polarizer only transmits about 50% of the light of an incident ray, the reflective cavity enables significant recycling and conversion of the reflected portions of the light to eventually be transmitted. With Example 2, the extractor is a polarization preserving diffuser, and the output of the backlight is partially polarized, with the highest intensity polarization orthogonal to the bulb axis, which is also the direction of the pass axis of the reflective polarizer on the acrylic plate. This effect can be used to advantage by aligning this axis with the pass axis of the bottom absorbing polarizer of the LCD panel to increase the brightness of the display.

FIG. 31 illustrates the reflectance spectra 190 and transmission spectra 192 for the PEN/PMMA reflector 92 of FIG. 12. One example of a desirable reflectance and transmission spectra 194 and 196 for a reflector would be fairly flat across the various colors. The optimum level of reflectance depends on the reflectance efficiency of the backlight and can be determined experimentally. In certain embodiments, this reflector preferably has little or substantially no absorption of light, in which case the transmission spectrum will be given by T=1−R. In one example, the transmission spectra 194 is fairly flat at about 70% reflectance and the transmission spectra 196 is fairly flat at about 30% transmittance.

The use of a diffuser as a light redirecting layer can mask color problems arising from a non-uniform reflectivity as a function of wavelength. It is preferable however to use reflectors that exhibit uniform transmission as a function of wavelength. Such reflectors can be made as follows.

### Spectral Control

The control of color in these broadband partial reflectors is important as they are used in color displays. The color is controlled by the shape of the reflectance spectrum. U.S. Pat. Nos. 5,126,880 and 5,568,316 teach the use of combinations of thin and very thick layers to reduce the iridescence of multilayer interference reflectors. If a high reflectivity is desired at some angle, e.g. at normal incidence, then a large number of layers is required with this approach, and this results in a very thick film.

An alternative approach is to use all or mostly quarter-wave film stacks. In this case, control of the spectrum requires control of the layer thickness profile in the film stack. A broadband spectrum, such as one required to reflect visible light over a large range of angles in air, requires a large number of layers if the layers are polymeric, due to the relatively small index differences achievable with polymer films compared to inorganic films. Polymeric multilayer optical films with high layer counts (greater than about 250 layers) have traditionally been made using a layer multiplier, i.e. they have been constructed of multiple packets of layers which were generated from a single set of slot generated layers in a feedblock. The method is outlined in U.S. Pat. No. 6,738,349.

Although multipliers greatly simplify the generation of a large number of optical layers, the distortions they impart to each resultant packet of layers are not identical for each packet. For this reason, any adjustment in the layer thickness profile of the layers generated in the feedblock is not the same for each packet, meaning that all packets cannot be simultaneously optimized to produce a uniform smooth spectrum free of spectral leaks. If the number of layers generated directly in a feedblock do not provide sufficient reflectivity, then two or more such films can be laminated to increase the reflectivity. The method to produce a low color, or a controlled color spectrum, is therefore as follows:
1) The use of an axial rod heater control of the layer thickness values of coextruded polymer layers as taught in U.S. Pat. No. 6,783,349.
2) A feedblock design such that all layers in the stack are directly controlled by an axial rod heater zone during layer formation, i.e. no use of layer multipliers.
3) Timely layer thickness profile feedback during production from a layer thickness measurement tool such as e.g. an atomic force microscope (AFM), a transmission electron microscope, or a scanning electron microscope.
4) Optical modeling to generate the desired layer thickness profile
5) Repeating axial rod adjustments based on the difference between the measured layer profile and the desired layer profile.

Although not as accurate in general as an AFM, the layer profile can also be quickly estimated by integrating the optical spectrum (integrating the −Log(1−R) vs. wavelength spectrum). This follows from the general principle that the spectral shape of a reflector can be obtained from the derivative of the layer thickness profile, provided the layer thickness profile is monotonically increasing or decreasing with respect to layer number.

Recycling with Back Cavity

The lateral (spatial) distribution of light is also typically desired to be uniform.

This can be achieved with a reflective backlight cavity that contains at least one diffusive element which randomizes the recycled light. The use of multiple light sources and their spacing within the backlight can also be utilized to improve the uniformity of the light emitted from the backlight. FIG. 17 illustrates these concepts in backlight 3300, which includes a light cavity 3302, a reflector with an internal Brewster angle 3304, a diffuser 3306 and an optical light directing film 3307. The light cavity 3302 includes a diffuse mirror 3308, and a number of point, serpentine or line light sources 3310.

### Options for Reflective Polarizer

As discussed herein, some embodiments of the optical assembly of the present invention do not include a reflective polarizer. For embodiments that do include a reflective polarizer, there are many options for that component. Certain reflective polarizers exhibit an internal Brewster angle, while others do not, as discussed in more detail herein. A reflective polarizer used can have orthogonal reflection and transmission axes.

The reflective polarizer can be or comprise, for example, any of the dual brightness enhancement film (DBEF) products or any of the diffusely reflective polarizing film (DRPF) products, or any of the APF products available from 3M Company under the Vikuiti brand, or one or more cholesteric polarizing films. Wire grid polarizers, such as those described in U.S. Pat. No. 6,243,199 (Hansen et al.) and U.S. Patent Publication 2003/0227678 (Lines et al.) are also suitable reflective polarizers. Uniaxially oriented specularly reflective multilayer optical polarizing films are described in U.S. Pat. No. 5,882,774 (Jonza et al.), U.S. Pat. No. 5,612,820 (Schrenk et al.), and WO 02/096621 A2 (Merrill et al.). Diffusely reflective polarizers having a continuous phase/disperse phase construction are described, for example, in 5,825,543 (Ouderkirk et al.). In some cases, such as with 3M™ Vikuiti™ Dual Brightness Enhancement Film-Diffuse (DBEF-D) available from 3M Company, the diffusely reflective polarizer also transmits light diffusely. Known cholesteric reflective polarizers are another type of reflective polarizer suitable for use in the disclosed backlight embodiments. In cases where the display panel 12 to be used with the backlight 30 includes its own rear polarizer for placement proximate the backlight, such as with most LCD displays, it is desirable to configure front reflective polarizer 32 to be in alignment with the display panel rear polarizer, or vice versa, for maximum efficiency and illumination. The rear polarizer of an LCD display panel is usually an absorbing polarizer, and usually is positioned on one side of a pixilated liquid crystal device, on the other side of which is a display panel front polarizer.

### Options for Back Reflector

For increased illumination and efficiency, it is also advantageous that the back reflector not only have overall high reflectivity and low absorption but also be of the type that at least partially converts the polarization of incident light upon reflection. That is, if light of one polarization state is incident on the back reflector, then at least a portion of the reflected light is polarized in another polarization state orthogonal to the first state.

Many diffuse reflectors have this polarization-converting feature. One class of suitable diffuse reflectors are those used for example as white standards for various light measuring test instruments, made from white inorganic compounds such as barium sulfate or magnesium oxide in the form of pressed cake or ceramic tile, although these tend to be expensive, stiff, and brittle. Other suitable polarization-converting diffuse reflectors are (1) microvoided particle-filled articles that depend on a difference in index of refraction of the particles, the surrounding matrix, and optional air-filled voids created from stretching and (2) microporous materials made from a sintered polytetrafluoroethylene suspension or the like, and (3) structured surfaces such as a surface diffuser coated with reflective material such as silver. Another useful technology for producing microporous polarization-converting diffusely reflective films is thermally induced phase separation (TIPS). This technology has been employed in the preparation of microporous materials wherein thermoplastic polymer and a diluent are separated by a liquid-liquid phase separation, as described for example in U.S. Pat. Nos. 4,247,498 (Castro) and 4,867,881 (Kinzer). A suitable solid-liquid phase separation process is described in U.S. Pat. No. 4,539,256 (Shipman). The use of nucleating agents incorporated in the microporous material is also described as an improvement in the solid-liquid phase separation method, U.S. Pat. No. 4,726,989 (Mrozinski). Further suitable diffusely reflective polarization-converting articles and films are disclosed in U.S. Pat. No. 5,976,686 (Kaytor et al.).

In some embodiments the back reflector 34 can comprise a very high reflectivity specular reflector, such as multilayer polymeric Enhanced Specular Reflector (ESR) film available from 3M Company under the Vikuiti brand, optionally in combination with a quarter wave film or other optically retarding film. Alanod™ brand anodized aluminum sheeting and the like are another example of a highly reflective specular material. As an alternative to constructions discussed above, polarization conversion can also be achieved with a combination of a high reflectivity specular reflector and a volume diffusing material disposed between the back reflector and the front reflective polarizer, which combination is considered for purposes of this application to be a polarization-converting back reflector. Alternatively, diffusing materials or microstructured features can be applied to the surface of the specular reflector.

When back reflector 34 is of the polarization-converting type, light that is initially reflected by reflective polarizer 32, because its polarization state is not transmitted by the polarizer, can be at least partially converted after reflection by the back reflector 34 to light whose polarization state will now pass through the reflective polarizer, thus contributing to overall backlight brightness and efficiency.

Disposed within the cavity between the reflective polarizer 32 and the back reflector 34 are sources 36. From the standpoint of the viewer, and in plan view, they are disposed behind the reflective polarizer 32. The outer emitting surface of the light sources is shown to have a substantially circular cross-section, as is the case for conventional fluorescent tubes or bulbs, but other cross-sectional shapes can also be used. The number of sources, the spacing between them, and their placement relative to other components of the backlight can be selected as desired depending on design criteria such as power budget, overall brightness, thermal considerations, size constraints, and so forth.

Various modifications and alterations of this invention will be apparent to those skilled in the art without departing from the scope and spirit of this invention, and it should be understood that this invention is not limited to the illustrative embodiments set forth herein. All U.S. patents, patent application publications, and other patent and non-patent documents referred to herein are incorporated by reference, to the extent they are not inconsistent with the foregoing disclosure.

What is claimed is:

1. An optical assembly comprising:
a reflector having an internal Brewster angle; and
a reflective polarizer having orthogonal reflection and transmission axes.

2. The optical assembly of claim 1 further comprising one or more lamps, wherein the reflective polarizer is located between at least one of the one or more lamps and the reflector.

3. The optical assembly of claim 1 further comprising one or more lamps, wherein the reflector is located between at least one of the one or more lamps and the reflective polarizer.

4. The optical assembly of claim 1 wherein the reflector is an isotropic layered assembly.

5. The optical assembly of claim 1 wherein the reflector comprises portions within the reflector that have a different index of refraction than a material that surrounds the portions.

6. The optical assembly of claim 5 wherein at least some of the portions are disc-shaped.

7. The optical assembly of claim 5 wherein the portions have a lower index of refraction than the surrounding material.

8. The optical assembly of claim 1 wherein the reflector is a cholesteric reflector.

9. The optical assembly of claim 1 wherein the reflector has a reflectivity for p-polarized light that decreases as an angle of incidence increases.

10. The optical assembly of claim 1 wherein the reflector is a multilayer dielectric reflector.

11. The optical assembly of claim 1 wherein the reflective polarizer is polymeric.

12. A direct lit backlight assembly comprising:
one or more lamps;
a reflector having an internal Brewster angle, wherein a major surface of the reflector is facing at least one of the one or more lamps; and
a light redirecting layer.

13. The backlight assembly of claim 12 wherein the one or more lamps comprise a point source lamp, a line source lamp or a serpentine source lamp.

14. The backlight assembly of claim 12 wherein the reflector has an internal Brewster angle that is accessible from air.

15. The backlight assembly of claim 12 wherein the Brewster angle is not accessible from air.

16. The backlight assembly of claim 12 further comprising a light injection layer between the one or more lamps and the reflector, wherein the light injection layer increases the range of propagation angles.

17. The backlight assembly of claim 12 wherein the light redirecting layer enables access to a wider range of propagation angles.

18. The backlight assembly of claim 12 wherein the light redirecting layer is selected from the group consisting of a diffuser, a brightness enhancement film, and a prismatic assembly.

19. The backlight assembly of claim 12 further comprising a reflective polarizer.

20. The backlight assembly of claim 19 wherein the reflective polarizer does not have an internal Brewster angle in the plane of incidence that is parallel to a block axis of the reflective polarizer.

21. The backlight assembly of claim 19 further comprising a second light redirecting layer.

22. The direct lit backlight assembly of claim 19 wherein the reflective polarizer is positioned between the one or more lamps and the reflector.

23. The backlight assembly of claim 12 wherein the one or more lamps are within a projected area of the major surface of the reflector.

24. The direct lit backlight assembly of claim 12 wherein the reflector is positioned between the one or more lamps and the light directing layer.

25. The direct lit backlight assembly of claim 12 wherein the light redirecting layer and reflector are positioned directly above the one or more lamps.

26. An optical assembly comprising:
one or more lamps;
a display panel;
a reflector having an internal Brewster angle, wherein the reflector is a multilayer interference film of at least three layers, wherein at least one of the layers is birefringent, wherein a refractive index in the x-direction (nₓ) is less than a refractive index in the z-direction (n_{z}), where the x-direction is an in-plane direction, wherein the reflector is located between the lamps and the display panel.

27. An optical assembly comprising:
a backlight reflector having a smooth side, wherein the reflector has an internal Brewster angle of less than 90 degrees in air, wherein the internal reflectivity inside the film for one polarization is zero for a certain angle; wherein the reflector has a reflectance of 50% or greater at normal incidence.
